(19) United States
(12) Patent Application Publication
(10) Pub. No.: US 2005/0058582 A1
(43) Pub. Date: Mar. 17, 2005

(54) Motor vehicle heating/air-conditioning installation

(75) Inventors: Carine Paumier, Versailles (FR); Frederic Ladrech, Maurepas (FR)

Correspondence Address: Valeo Climate Control Corp.;Intellectual Property Dept, 4100 North Atlantic Boulevard, Auburn Hills, MI, 48326, US

(73) Assignee: Valeo Climatisation S.A., La Verriere (FR)

(21) Appl. No.: 10/938,055

(22) Filed: Sep. 10, 2004

(30) Foreign Application Priority Data
Sep. 12, 2003 (FR) 03 10730

(51) Int. Cl. B01J 19/08

(52) U.S. Cl. 422/186.04

(57) ABSTRACT

In an installation for heating/air conditioning the cabin of a motor vehicle, comprising a powered fan unit (18) delivering a flow of air in an air distribution conduit (12) in which at least one evaporator (22) is disposed, an electrostatic filtration system (30) is provided, comprising an ionising part and a collecting part, placed upstream of a plasma catalysis system (40) comprising a plasma generating part.

### BACKGROUND TO THE INVENTION

The present invention concerns the purification of the air delivered in the cabin of a motor vehicle.

Traditionally, as illustrated in FIG. 10, a motor vehicle heating/air-conditioning installation comprises a housing 10 delimiting an air distribution channel or conduit 12 which, according to the position of the controlled distribution flaps 14, brings the air to be treated to outlet nozzles (for heating and demisting/defrosting 16) opening out in the cabin. The flow of air passing through the channel is produced by a powered fan unit or impeller 18 receiving external air or recirculation air coming from the cabin according to the position of a switching flap 20 disposed at the entrance to the housing. The cooling of the air is provided by at least one evaporator (or heat exchanger 22) disposed in the channel and conventionally preceded by a particle filter or a combined filter 24 including an activated carbon filter, or more generally with any adsorbent, for treating odorous or noxious gases. As for the heating of the air, this is provided by a radiator 26 preceded, as is known, by a controlled mixing flap 28.

With a filter with adsorbent, the molecules of polluting gases are retained by a phenomenon of adsorption on the porous surface of the adsorbent, a desorption or salting out of these pollutants then being able to be observed under certain temperature conditions.

Unfortunately, it is clear that this type of filter has a limited service life, resulting in a significant pressure drop and reduced efficacy with regard to the destruction and/or limitation of the proliferation of bacteria or micro-organisms present in the distribution conduit and introduced into the cabin through the outlet orifices.

### OBJECT AND SUMMARY OF THE INVENTION

The object of the invention is a heating/air-conditioning installation which is greatly improved compared with existing devices in that it very greatly limits and also destroys the micro-organisms and gases conveyed in the ambient air, giving rise to the unpleasant odours appearing in the cabin of a motor vehicle, and thus provides optimum filtration of the air delivered to the cabin.

Another aim of the invention is to produce such an installation reliably and with simple implementation.

These aims are achieved by virtue of an installation for heating/air conditioning the cabin of a motor vehicle comprising a powered fan unit delivering a flow of air in an air distribution conduit in which there is disposed at least one evaporator, characterised in that it comprises an electrostatic filtration system, comprising an ionising part and a collecting part, placed upstream of a plasma catalysis system comprising a plasma generating part and a catalysis part.

Through the association of these two systems, the air flow is perfectly filtered and the frequency of maintenance of the installation is reduced and the maintenance of the performance ensured between two maintenance operations.

Advantageously, the plasma generating part is disposed upstream of the evaporator.

According to the embodiment envisaged, the ionising part can be disposed upstream of the powered fan unit and upstream of a switching flap providing a switching of the air flow between the external air and the air coming from the cabin and the said collecting part can be disposed upstream of the powered fan unit and upstream of the said switching flap.

Advantageously, the said catalysis part can be disposed on a support of the non-woven or cellular type placed downstream of the evaporator or the said catalysis part can be formed by a surface of the evaporator. However, the said catalysis part can also be disposed in outlet nozzles opening out in the cabin downstream of the controlled distribution flaps.

The said ionising part of the electrostatic filtration system and the said plasma generating part of the plasma catalysis system preferably comprise common electronic components.

### BRIEF DESCRIPTION OF THE DRAWINGS

Other particularities and advantages of the device according to the invention will emerge from a reading of the description given below, by way of indication but non-limitingly, with reference to the accompanying drawings, in which:

FIG. 1 illustrates schematically a first example embodiment of a heating/air-conditioning installation according to the invention equipping a motor vehicle;

FIG. 2 shows the architecture of an electrostatic filtration system used in the heating/air-conditioning installation of FIG. 1;

FIG. 3 shows the architecture of a plasma catalysis system used in the heating/air-conditioning installation of FIG. 1;

FIG. 4 illustrates schematically a variant embodiment of the heating/air-conditioning installation of FIG. 1;

FIG. 5 illustrates schematically another variant embodiment of the heating/air-conditioning installation of FIG. 1;

FIG. 6 illustrates schematically yet another variant embodiment of the heating/air-conditioning installation of FIG. 1;

FIG. 7 illustrates schematically a last variant embodiment of the heating/air-conditioning installation of FIG. 1;

FIG. 8 illustrates schematically another embodiment of a heating/air-conditioning installation according to the invention equipping a motor vehicle;

FIG. 9 illustrates schematically yet another example embodiment of a heating/air-conditioning installation according to the invention equipping a motor vehicle; and

FIG. 10 illustrates a heating/air-conditioning installation of the prior art equipping a motor vehicle.

### DETAILED DESCRIPTION OF EMBODIMENTS

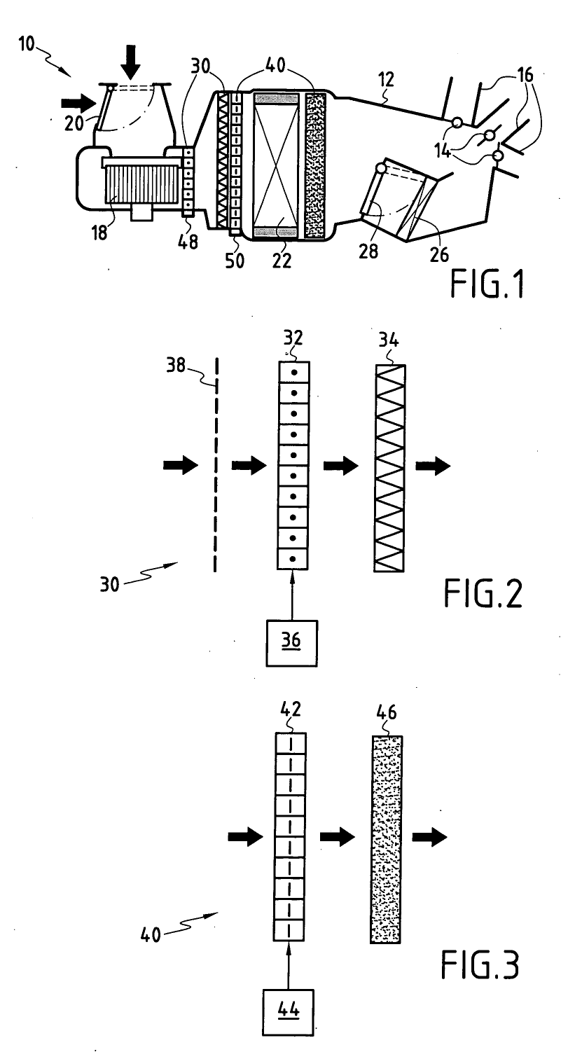

FIG. 1 illustrates schematically a first example embodiment of a motor vehicle air-conditioning installation according to the invention.

This architecture is characterised by the combined use, in the air distribution conduit 12, of a housing 10 of such a heating/air-conditioning installation comprising at least one evaporator 22, an electrostatic filtration system 30 for the treatment of particles with a diameter of between 0.1 microns and 10 microns (and more) and a plasma catalysis system 40 for treating polluting gases, odours and micro-organisms.

The electrostatic filtration increases the efficacy of collection of the atmospheric aerosols of small dimensions (in particular having diameters of less than 0.5 microns) acting on their electrical charge. As illustrated by FIG. 2, the particles passing through the system are charged by an ionising part 32 before being collected by a collecting part 34 conventionally formed from a particle filter, made from non-woven fibres for example, folded in a concertina in order to show V-shaped undulations or folds in order to increase the useful surface of the filter and reduce the pressure drop.

The electrostatic charge is effected from a high-voltage DC electrical supply 36 of between 2 and 8 kV (typically 5 kV) and usually applied in the form of corona discharges to a plurality of small-diameter electric wires disposed in alternation with parallel conductive plates. A pre-filtration grille 38 is advantageously placed upstream of the ionising part in order to filter coarse elements having dimensions greater than a given size, for example 5 mm. The particles downstream of the grille 38 are thus ionised by the ioniser 32 before being collected by the particle filter 34.

The plasma catalysis consists of purifying the air flow by the simultaneous action of a plasma generating part formed by one or more plasma generators and a catalysis part formed by one or more catalysts (based on metallic oxide for example) deposited on a support of the non-woven or cellular type (honeycombs for example) or on a metallic surface.

As illustrated in FIG. 3, the plasma generating part 42 can advantageously use corona discharges or discharges of the DBD (Dielectric Barrier Discharge) type applied to various configurations of electrode: wire/plane, cylinder/plane, or plane/plane for example. These discharges are generated by a high-voltage AC electrical supply 44, preferably using electronic components common to the one supplying the ionising part, between 3 kV and 15 kV. The power required is between 50 and 200 W with frequencies above 50 kHz.

The air passing through the system is treated by the plasma created by the generating part 42 before being collected by the catalysis part 46. The catalyst can be deposited alone or in addition to an adsorbent such as activated carbon, zeolite, a mixture of the two, or any other adsorbent. The activated carbon consists for example of grains with dimensions of around 0.5 mm to 2 mm. These grains are porous with micropores with dimensions of around 0.2 nm to 2 nm, mesopores with dimensions of around 2 nm to 50 nm and macropores with dimensions above 50 nm. The catalyst can for example be composed of manganese and/or iron oxides.

Consequently the type of oxide particles and their proportion by weight with respect to the activated carbon is chosen so that the pores of the latter are not obstructed. This ratio by weight is for example between 1% and 20%.

Let us return to FIG. 1. According to the invention, the electrostatic filtration system 30 is placed upstream of the plasma catalysis system 40 so as to limit clogging (and/or poisoning) of the latter, which is thus protected from the concentration of particles and the generation of the plasma is effected upstream of the evaporator 22 so as to evenly purify, continuously or not, the exchange surface of this evaporator of the gases, odours and micro-organisms. Because of this, the odours generated by the phenomena of adsorption/desorption of the gaseous molecules and by the growth of micro-organisms on the surface and in the immediate environment of the evaporator are greatly limited. The treatment of the air flow is completed by means of the catalyst deposited on an independent support placed at the outlet from the evaporator. In addition, with this configuration, the air flow is filtered, whether it comes from the outside (direct flow mode) or from the cabin (recycling mode).

In order to facilitate its installation in the air distribution conduit 12, the electrostatic and plasma catalysis filtration systems are advantageously each mounted in a support frame, for example rectangular in shape, whose surface defines a visible treatment surface for the air passing through it and whose transverse sides have recesses 48, 50 intended to accept transformers (not shown) fixed to the edges of these recesses.

The transformers deliver a voltage of between 2 and 15 kV from the high-voltage supply (not shown) connected to the vehicle battery.

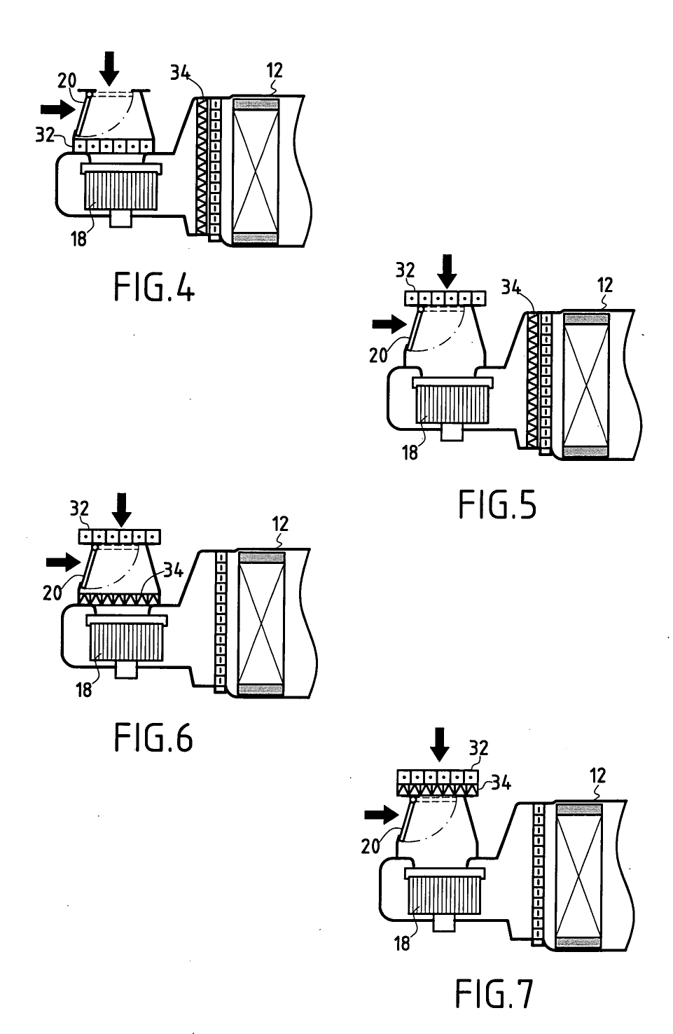

FIG. 4 illustrates a preferential variant embodiment in which the ionising part 32 of the electrostatic filtration system is now placed upstream of the impeller 18, so as to substantially improve the collection efficacy. This is because, through this configuration and because of the phenomena of coalescence, the system benefits from the turbulence caused by the impeller increasing the probability of meeting between particles.

In the variant embodiment in FIG. 5, this ionising part 32 is placed directly in the air inlet upstream of the switching flap 20 providing the switching of the air flow supplying the installation between the external air and the air coming from the cabin, the collecting part 34 remaining disposed downstream of the impeller 18. Thus the ionising part is easily accessible and uses the volume available at this point. On the other hand, in this configuration, the particles generated in recycling mode are only partially treated (since they are only filtered but not ionised).

When the volumes available in the conduit 12 are limited, recourse may be had to the variant embodiments in FIGS. 6 and 7.

In FIG. 6, the ionising part 32 is still disposed in the air inlet but the collecting part 34 is now disposed upstream of the impeller 18. In FIG. 7, it is the whole of the electrostatic filtration system 30; 32, 34 which is disposed in the air inlet and therefore easily accessible. However, with this configuration the particles generated in recycling mode are not treated.

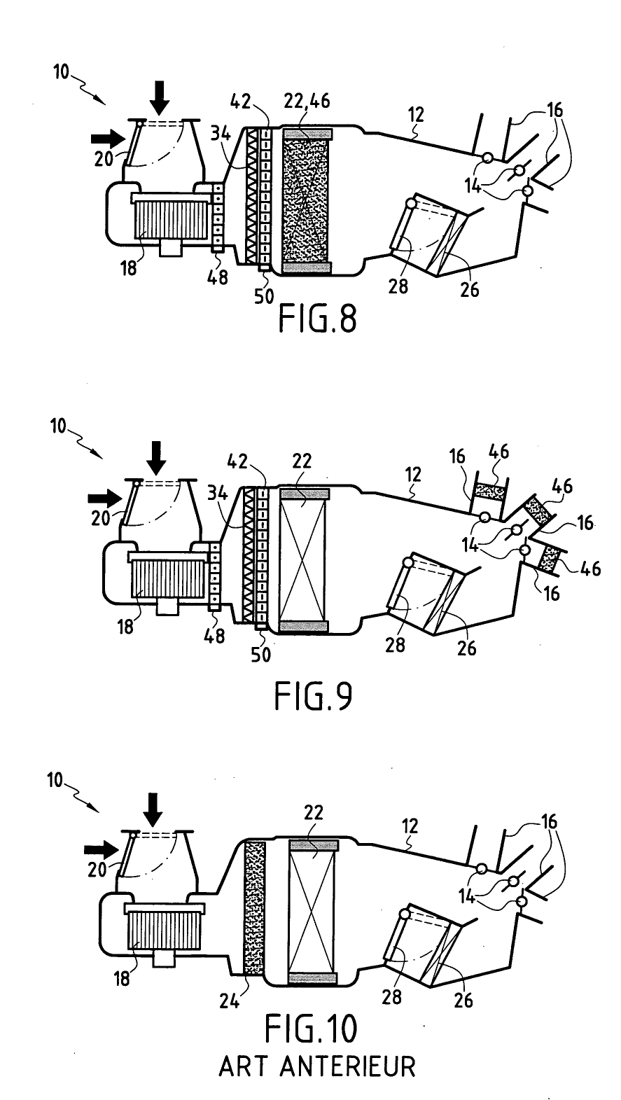

FIG. 8 shows another variant embodiment of the invention in which the support for the catalyst is formed directly by the evaporator 22. This is because this is covered with the catalyst, which can be integrated in the polymer covering of the evaporator, directly by means of a suitable metallic oxide. This configuration affords increased efficacy because of the large size of the surface deployed and therefore the contact time. A saving in volume and weight is also obtained by eliminating the catalyst support. In addition, the total pressure drop in the system is improved.

Finally, in FIG. 9, this catalyst is disposed in the area distribution zone which in general comprises many dead spaces (air conduits) and more precisely in the outlet orifices 16 opening into the cabin downstream of the controlled distribution flaps 14. Better acoustic insulation is thus provided, as close as possible to the passengers, with respect to the ventilation noises created in the evaporator and in the air conduits. In addition, its arrangement as close as possible to the air outlet orifices makes it possible to distribute to the passengers in the cabin an air which is cleaner (since it comes directly from the catalytic filtration) to the detriment however of any maintenance (still relatively easy since it is accessible) because of the need for access at several different points.

It should be noted that though preferentially the plasma generating part is placed upstream of the evaporator it is of course also possible to put it in front of the evaporator if space in the housing so permits.

1-10. (cancelled)

11. An installation for heating/air-conditioning the cabin of a motor vehicle, comprising a powered fan unit (18) delivering a flow of air in an air distribution conduit (12) in which at least one evaporator (22) is disposed, further comprising an electrostatic filtration system (30), the electrostatic filtration system comprising an ionising part (32) and a collecting part (34), placed upstream of a plasma catalysis system (40), the plasma catalysis system comprising a plasma generating part (42) and a catalysis part (46).

12. A heating/air-conditioning installation according to claim 11, wherein the plasma generating part (42) is disposed upstream of the evaporator (22).

13. A heating/air-conditioning installation as in claim 11, wherein the ionising part (32) is disposed upstream of the powered fan unit (18).

14. A heating/air-conditioning installation as in claim 12, wherein the ionising part (32) is disposed upstream of the powered fan unit (18).

15. A heating/air-conditioning installation as in claim 13, wherein the ionising part (32) is disposed upstream of a switching flap (20) providing a switching of the flow of air between the external air and the air coming from the cabin.

16. A heating/air-conditioning installation as in claim 15, wherein the collecting part (34) is disposed upstream of the powered fan unit (18).

17. A heating/air-conditioning installation as in claim 16, wherein the collecting part (34) is disposed upstream of the said switching flap (20).

18. A heating/air-conditioning installation as in claim 11, wherein the catalysis part (46) is disposed on a support of the non-woven or cellular type placed downstream of the evaporator (22).

19. A heating/air-conditioning installation as in claim 12, wherein the catalysis part (46) is disposed on a support of the non-woven or cellular type placed downstream of the evaporator (22).

20. A heating/air-conditioning installation as in claim 13, wherein the catalysis part (46) is disposed on a support of the non-woven or cellular type placed downstream of the evaporator (22).

21. A heating/air-conditioning installation as in claim 14, wherein the catalysis part (46) is disposed on a support of the non-woven or cellular type placed downstream of the evaporator (22).

22. A heating/air-conditioning installation as in claim 11, wherein the catalysis part (46) is formed by a surface of the evaporator (22).

23. A heating/air-conditioning installation as in claim 12, wherein the catalysis part (46) is formed by a surface of the evaporator (22)

24. A heating/air-conditioning installation as in claim 13, wherein the catalysis part (46) is formed by a surface of the evaporator (22)

25. A heating/air-conditioning installation as in claim 14, wherein the catalysis part (46) is formed by a surface of the evaporator (22)

26. A heating/air-conditioning installation as in claim 11, wherein the catalysis part (46) is disposed in outlet nozzles (16) opening out in the cabin downstream of the controlled distribution flaps (14).

27. A heating/air-conditioning installation as in claim 12, wherein the catalysis part (46) is disposed in outlet nozzles (16) opening out in the cabin downstream of the controlled distribution flaps (14).

28. A heating/air-conditioning installation as in claim 13, wherein the catalysis part (46) is disposed in outlet nozzles (16) opening out in the cabin downstream of the controlled distribution flaps (14).

29. A heating/air-conditioning installation as in claim 14, wherein the catalysis part (46) is disposed in outlet nozzles (16) opening out in the cabin downstream of the controlled distribution flaps (14).

30. A heating/air-conditioning installation as in claim 11, wherein the ionising part (32) of the electrostatic filtration system (30) and the plasma generating part (42) of the plasma catalysis system (40) comprise common electronic components.

31. A heating/air-conditioning installation as in claim 12, wherein the ionising part (32) of the electrostatic filtration system (30) and the plasma generating part (42) of the plasma catalysis system (40) comprise common electronic components.

32. A heating/air-conditioning installation as in claim 3, wherein the ionising part (32) of the electrostatic filtration system (30) and the plasma generating part (42) of the plasma catalysis system (40) comprise common electronic components.

33. A heating/air-conditioning installation as in claim 4, wherein the ionising part (32) of the electrostatic filtration system (30) and the plasma generating part (42) of the plasma catalysis system (40) comprise common electronic components.

34. A heating/air-conditioning installation as in claim 5, wherein the ionising part (32) of the electrostatic filtration system (30) and the plasma generating part (42) of the plasma catalysis system (40) comprise common electronic components
